(19) United States
(12) Patent Application Publication
(10) Pub. No.: US 2012/0189370 A1
(43) Pub. Date: Jul. 26, 2012

(54) MEDIA PROTECTOR FOR IMAGE-FORMING DEVICE

(75) Inventors: LAURENCE S. BARKER, FAIRPORT, NY (US); RICHARD J. MILILLO, FAIRPORT, NY (US); DAVID P. VAN BORTEL, VICTOR, NY (US); PIOTR SOKOLOWSKI, WEBSTER, NY (US); ROGER LEIGHTON, HILTON, NY (US); JASON M. LeFEVRE, PENFIELD, NY (US); JENNIFER J. REA, RUSH, NY (US)

(73) Assignee: XEROX CORPORATION, Norwalk, CT (US)

(21) Appl. No.: 13/012,806

(22) Filed: Jan. 25, 2011

(51) Int. Cl. B41J 15/04

(52) U.S. Cl. 400/611

(57) ABSTRACT

A system for protecting media in an image-forming device. The system includes a heating element for heating the media, and a media path adjacent to the heating element. The media is transported in the image-forming device along the media path. The system also includes a barrier assembly having one or more non-flammable restraint threads and a spring-tensioned positioner. The restraint threads are mounted between the heating element and the media path, and the spring-tensioned positioner assembly maintains the restraint thread in a fixed position.

### TECHNICAL FIELD

The presently disclosed embodiments generally relate to continuous feed printing environments, and more particularly, to media handling during printing processes.

### BACKGROUND

A continuous feed (CF) printer prints on a band/roll of paper, which is separated into single sheets after printing. Many industries, such as banks, insurance companies, and print shops use CF printing systems for printing items such as forms and invoices. These systems generally provide high-speed prints with fewer registration errors.

A typical CF printing system transports significant amount of paper along its media path. The term “media path” refers to the route followed by media, such as paper, through an imaging-forming system. In the CF system, the media path includes equipment such as shafts, rollers, and diverting mechanisms, all used for transporting media through the system.

Along the media passage, media imaged with ink droplets passes through a radiant heater. As the media passes through the radiant heater, the heat causes the ink to further melt and flow, thereby fusing the ink to the media and forming an image. During the heating process, if the media comes in direct contact with the radiant heater or comes too close to the radiant heater, the media may ignite.

In addition, a fault may occur in the CF printers, causing the media to slow down while passing through the radiant heater. The slow speed may cause the media to catch fire in the event that it remains underneath the radiant heater for a prolonged time.

It would be highly desirable to protect the media from catching fire and resulting in any accident.

### SUMMARY

The present disclosure describes a system for protecting media in an image-forming device. The system includes a heating element for heating the media, and a media path adjacent to the heating element. The media is transported in the image-forming device along the media path. The system also includes a barrier assembly having one or more non-flammable restraint threads and a spring-tensioned positioner. The restraint threads are mounted between the heating element and the media path, and the spring-tensioned positioner assembly maintains the restraint thread in a fixed position.

### BRIEF DESCRIPTION OF THE DRAWINGS

FIG. 1 illustrates an image-forming device.

FIG. 2A illustrates an embodiment of the present disclosure with heating element in an operating position

FIG. 2B illustrates an embodiment of the present disclosure with heating element in a non-operating position

FIGS. 3A and 3B illustrate alternate embodiments of a barrier assembly of FIG. 2B

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### Overview

The present disclosure describes various embodiments of a system providing a guard for media in an image-forming device, such as a continuous feed printer. The media moves along a media path having equipment for transporting the continuous media. During transportation, a heating element heats the media along with the ink droplets deposited on the media for forming an image on the media.

For purposes of description, the present disclosure is discussed in relation to continuous feed printing systems; those skilled in the art, however, will appreciate that the subject matter disclosed may be applicable to any image-forming device that may face media damaging issues. The term “media” used in the present disclosure refers to continuously fed media of paper, plastic, or other suitable material.

### Exemplary Embodiments

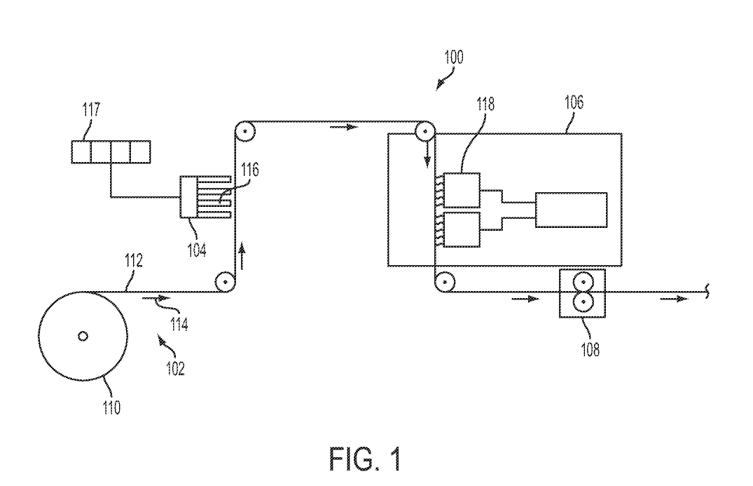

FIG. 1 illustrates an image-forming device 100 for supplying, transporting, and printing media. The image-forming device 100 includes a media supply assembly 102, a printhead assembly 104, a media heating assembly 106, and a fixing assembly 108. The media supply assembly 102 may include one or more media supply rolls 110 for supplying the media, such as media 112, for printing. The supply assembly 102 is configured to feed the media 112 in a known manner along a media path 114 in the image-forming device 100 through a print zone 116, and past the media heating assembly 106, and through the fixing assembly 108.

The printhead assembly 104 discharges ink droplets directly onto the media 112 as the media 112 moves through the print zone 116. The printhead assembly 104 receives the ink from an ink supply assembly 117. Once the ink droplets are deposited, the media 112 moves through the media heating assembly 106. The media heating assembly 106 includes one or more heating elements 118 that radiate heat onto the media 112. The media 112 and the ink droplets on the media 112 absorb this radiation. The radiation further melts the ink droplets, making the ink flow and fuse to the media 112. The fused ink forms the desired image on the media 112. It will be evident to those skilled in the art that the media 112 is heated at a suitable color temperature known in the art.

The heated media 112 then passes through the fixing assembly 108 for permanently securing the desired image to the media 112. Specifically, the fixing assembly 108 flattens the heated ink droplets on the media 112 by applying pressure and heat, thereby permanently fixing the image on the media 112.

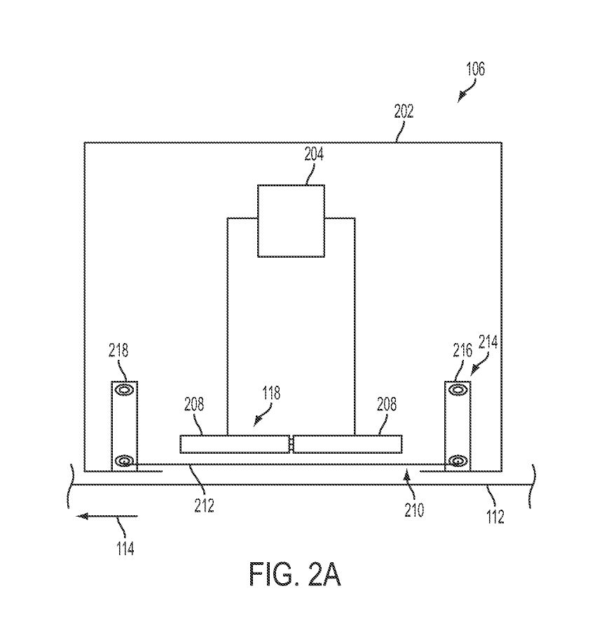

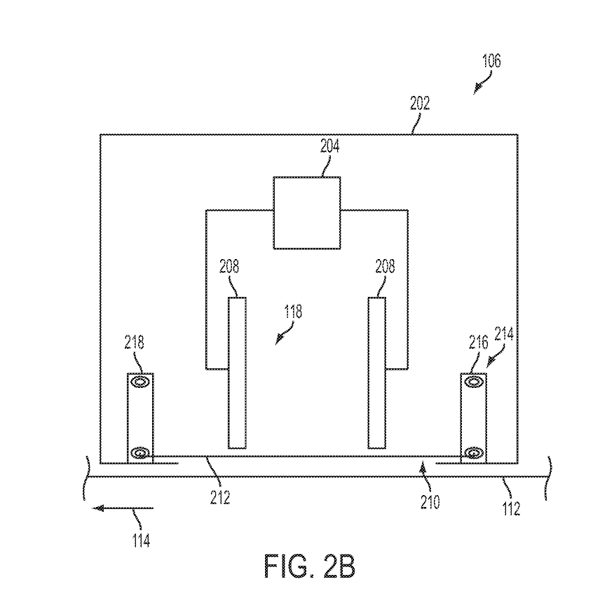

FIG. 2A illustrates an exemplary embodiment of the present disclosure with the heating element 118 of the heating assembly 106 in the operating position. FIG. 2B illustrates an exemplary embodiment of the present disclosure with the heating element 118 in the non-operating position. As shown, the heating assembly 106 includes conventional heating components such as a frame 202 for mounting and supporting the heating assembly 106 above the media 112 and the media path 114, and an actuator 204. The heating assembly 106 also includes a pair of gas springs (not shown), and the heating element 118 includes a pair of heating panels 208. The actuator 204, operably coupled to the heating panels 208, selectively moves the heating panels 208 between an operating position and a non-operating position. In addition, the gas spring aids in moving the panels 208 towards the non-operating position.

A barrier assembly 210 is mounted between the heating element 118 and the media 112 transported along the media path 114. The barrier assembly 210 includes one or more non-flammable restraints such as a restraint thread 212. The restraint thread 212 is mounted adjacent to the media path 114 near a leading edge and a trailing edge of the heating element 118 so that the restraint thread 212 remains at a fixed position. The leading edge refers to the edge from where the media 112 arrives underneath the heating element 118 from the media supply assembly 102 (FIG. 1). The trailing edge is the edge from which the media 112 moves towards the fixing assembly 108.

To maintain the restraint thread 212 in a fixed position, the barrier assembly 210 includes a spring-tensioned positioner assembly 214 perpendicular to the media path 114. In the present embodiment, the positioner assembly 214 includes a first positioner 216 and a second positioner 218. As shown, the first and the second positioners 216 and 218 are located near the leading and trailing edges of the heating element 118 respectively, perpendicular to the media path 114. The positioner assembly 214 holds the restraint thread 212 in a fixed position from both ends for preventing the restraint thread 212 to loosen. Specifically, the positioner assembly 214 engages the restraint thread 212 by clamping and supporting the thread 212 at a fixed position above and parallel to the web media 112, and applying tension to the thread 212. The diameter of the restraint thread 212 lies within a range of approximately 0.020 inches to 0.025 inches. The referenced diameter range is small enough to prevent the restraint thread 212 from casting a shadow on the media and enables uniform heating of the media 112.

In the operating position (FIG. 2A), each of the heating panels 208 face the media 112, while in the non-operating position (FIG. 2B), the heating panels 208 are pivoted so that they are substantially perpendicular to the media 112, i.e., in a position at 90 degrees angle from the operating position, and facing each other. In addition, the thermal heating of the media 112 and the ink droplets is discontinued in the non-operating position.

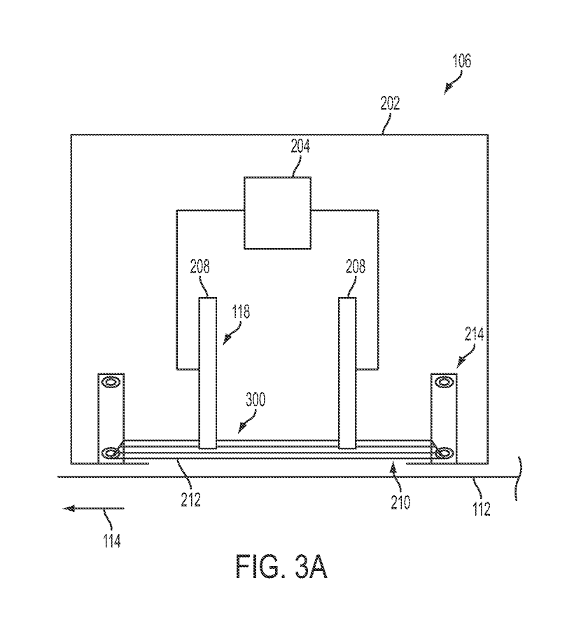

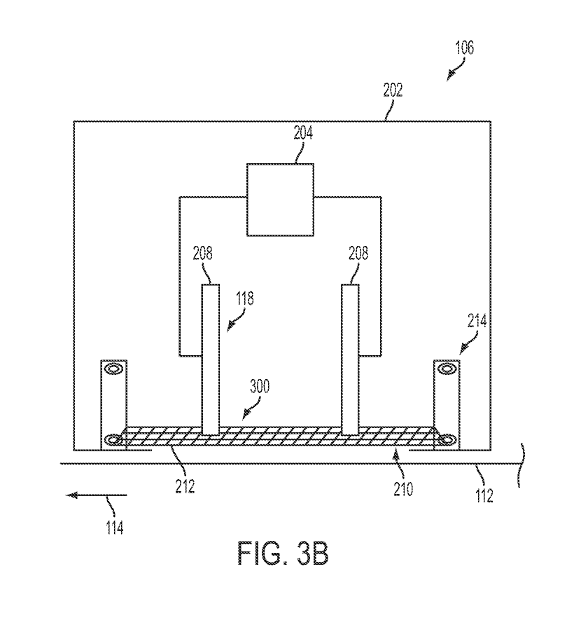

Apart from a single restraint thread 212, in an alternate embodiment, the barrier assembly 210 may include a number of restraint threads 212, arranged to form a mesh 300, illustrated in FIG. 3A. The mesh 300 is mounted between the heating element 118 and the media 112 at a fixed position using the positioner assembly 214. The positioner assembly 214, in the present embodiment, includes a multiple positioners. The multiple positioners engage the mesh 300 at both the ends in a fixed position.

FIG. 3B illustrates an alternate embodiment of the mesh 300. As shown, the mesh 300 includes two sets of parallel multiple restraints threads 212. Specifically, one set of restraints is arranged at an angle with the second set. Alternatively, the first set may be perpendicular to the second set. Also, the mesh 300 may be held in a fixed position within a rectangular closed frame or a circular closed frame.

Further, in the mesh 300, the distance between the restraint threads 212 lies within a range of approximately ¾ inch to 3 inches. This range is large enough to prevent any interference during the heating of the media 112, thereby enabling uniform heating of the media 112 by the heating element 118.

The restraint thread 212 is composed of at least one flame-resistant material. The flame-resistant material may be a fiberglass material, an inconel material, or a combination of the fiberglass and inconel materials. Any other suitable flame-resistant material known in the art may also be used for manufacturing the restraint thread 212.

In the present embodiment of the disclosure, the restraint thread 212 is composed of both fiberglass and inconel material. Specifically, the thread 212 is formed as a composite, with inconel embedded in fiberglass.

As known in the art, the fiberglass material is used for applications requiring intermediate capability up to 790° C. The fiberglass material thus provides a high thermal resistance. Inconel material adds strength to the restraint thread 212.

In addition, the inconel material is electrically conductive and forms a component of an electrical circuit in the image-forming device 100. Because the inconel material forms a part of the electrical circuit, a breakage in the restraint thread 212 breaks the circuit of the image-forming device 100, thereby resulting in a fault in the image-forming device 100.

On detection of a fault, the heating panels 208 retract to the non-operating position at a right angle (90 degrees) from the operating position. Specifically, the actuator 204 retracts the heating panels 208 to move the heating element 118 away from the media 112. This operation discontinues the function of the heating element 118 and prevents the thermal heating of the media 112. Accordingly, the non-operating position precludes the ignition of the media 112 even though the media 112 remains under the heating assembly 106 for a long time.

It should be noted that the description below does not set out specific details of manufacture or design of the various components. Those of skill in the art are familiar with such details, and unless departures from those techniques are set out, techniques, designs and materials known in the art should be employed. Those in the art are capable of choosing suitable manufacturing and design details.

The terminology used herein is for the purpose of describing particular embodiments only and is not intended to be limiting of the disclosure. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A system for protecting media in an image-forming device comprising:
a heating element;
a media path adjacent to the heating element; and
a barrier assembly including:
one or more non-flammable restraint threads mounted between the heating element and the media path; and
a spring-tensioned positioner assembly, located adjacent to the media path and adapted to maintain each restraint thread in a fixed position.

2. The system of claim 1, wherein the spring-tensioned positioner assembly comprises a pair of positioners.

3. The system of claim 1, wherein the spring-tensioned positioner assembly comprises a plurality of positioners.

4. The system of claim 1, wherein the spring-tensioned positioner assembly comprises a closed frame.

5. The system of claim 1, wherein the non-flammable restraint threads form a mesh.

6. The system of claim 5, wherein distance between each restraint thread lies within a range of approximately ¾ inch to 3 inches for enabling uniform heating of the media by the heating element.

7. The system of claim 1, wherein the heating element comprises a pair of panels capable of retracting to a position at a right-angle (90 degrees) from an operating position.

8. The system of claim 1, wherein the non-flammable restraint threads are composed of at least one flame-resistant material.

9. The system of claim 8, wherein the flame-resistant material is a fiberglass material, an inconel material, or a combination thereof.

10. The system of claim 8, wherein a flame-resistant material of the at least one flame-resistant material is electrically conductive and forms a component of an electrical circuit.

11. The system of claim 10, wherein a breakage in the restraint thread results in the circuit breakage, thereby causing a fault in the image-forming device.

12. The system of claim 11, wherein the pair of panels retracts on detection of the fault in the image-forming device.

13. The system of claim 1, wherein diameter of each restraint thread lies within a range of approximately 0.020 inches to 0.025 inches for enabling uniform heating of the media by the heating element.

14. A barrier assembly for protecting media in an image-forming device having a heating element and a media path adjacent to the heating element, the barrier assembly comprising:
one or more non-flammable restraint threads mounted between the heating element and the media path; and
a spring-tensioned positioner assembly, located adjacent to the media path and adapted to maintain each restraint thread in a fixed position.
